(19) United States
(12) Patent Application Publication
(10) Pub. No.: US 2010/0138893 A1
(43) Pub. Date: Jun. 3, 2010

(54) PROCESSING METHOD FOR ACCELERATING PACKET FILTERING

(75) Inventors: Yan Li, Tianjin (CN); Tom Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/326,151

(22) Filed: Dec. 2, 2008

(51) Int. Cl. G06F 17/00; H04L 9/00

(52) U.S. Cl. 726/1

(57) ABSTRACT

A processing method for accelerating packet filtering is used for accelerating the filtering process of packet data in a computer. The processing method accelerating packet filtering includes the steps. A plurality of packet filtering policies is loaded. Feature values of each packet filtering policy are resolved. A grouping procedure is performed on the packet filtering policies according to the feature values, so as to add the packet filtering policies meeting a threshold value to corresponding policy groups. A performing sequence of the packet filtering policies in the policy groups is determined according to a performing sequence of the packet filtering policies. A performing sequence of the policy groups is determined according to a producing sequence of the policy groups. A plurality of packet data is received. When the packets don't match the policy groups, the default policy is processed according to protocol information of the packets.

### BACKGROUND OF THE INVENTION

1. Field of Invention

The present invention relates to a packet processing method, and more particularly to a processing method for accelerating filtering of packet content.

2. Related Art

All of the current firewall static packet filtering technologies are implemented by using a series of rule chains. The maintenance and management of the rule chains are completed by a system administrator. Each node (that is, filtering policy) in a rule chain is consisted of packet data filtering policies set by the system administrator.

After the above rule chains are determined, a system device filters the received packet data one by one according to every filtering rule in the rule chain. In this process, a packet may match a piece of particular rule, or may not match any rules at all.

The packet data being filtered is processed during the packet filtering in the following manners. In the first case, that is, if a packet matches a piece of corresponding policy during the filtering, the system stops the performance of other filtering policies in the rule chains on the packet data. In the second case, that is, if the packet does not match any pieces of corresponding filtering policies during the filtering, the arbitration for the packet is determined by the system.

For the administrator, this manner can add filtering policies rapidly, but it results in the reduction in flexibility for maintenance and integration of the filtering policies.

### SUMMARY OF THE INVENTION

In the light of the above problems, the present invention is directed to a processing method for accelerating packet filtering, which is used to accelerate the process of filtering packet data in a computer.

For the above-mentioned purpose, the present invention provides a processing method for accelerating packet filtering, which includes the following steps. A rule chain including a plurality of packet filtering policies is loaded. A plurality of batches of packet data is received. If a policy group is found to match the packet, the packet is filtered by using all the filtering policies in the policy group one by one. When it is found that a packet has no policy group to match with it, a new policy group is established according to protocol information of this packet. Then, it is verified whether the filtering policy should be added to the newly established policy group or not according to the matching relationship between feature values of each packet filtering policy and feature values of this newly established policy group. The packet information is filtered by using the policy group respectively. If there is a packet which does not match any policy groups, a corresponding policy group is added dynamically according to the protocol information of the packet. The filtering operation is repeated until the filtering of all packet data is completed.

In the present invention, a grouping process is performed on a plurality of packet filtering policies sequentially performed in a rule chain, such that interrelated filtering policies are integrated into the same policy group, and then the filtering policies in the policy group are performed sequentially. This can reduce the complexities of the dispatch and comparison of resources, thereby accelerating the speed of filtering the packet data.

The features and practices of the present invention will be illustrated from the detailed description of the best embodiments when read in conjunction with accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic flow chart of operation of the present invention.

FIG. 2A is a schematic view of a filtering policy in a rule chain.

FIG. 2B is a schematic view of a first policy group of the present invention.

FIG. 2C is a schematic view of a second policy group of the present invention.

FIG. 2D is a schematic view of a third policy group of the present invention.

FIG. 2E is a schematic view of a fourth policy group of the present invention.

FIG. 3 is a schematic view of the performing sequence of the present invention.

### DETAILED DESCRIPTION OF THE INVENTION

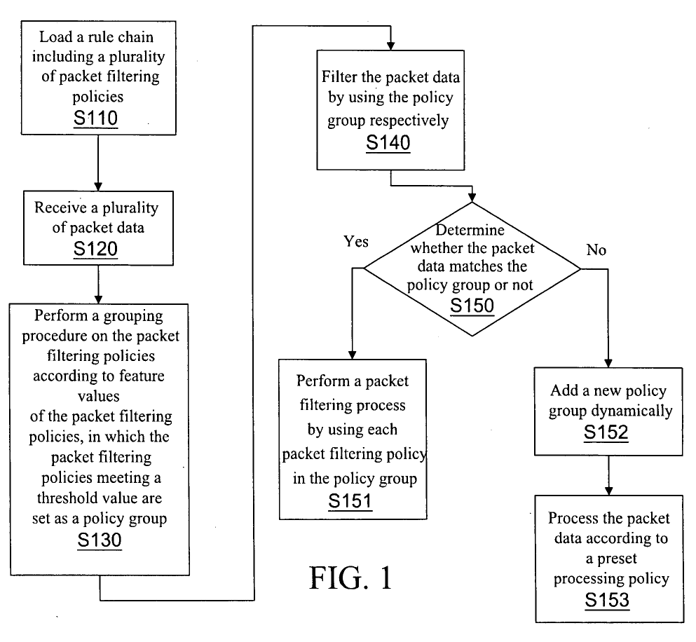

Referring to FIG. 1, a schematic flow chart of operation of the present invention is shown. The present invention can be implemented in a computer device with network packet filtering, such as, a personal computer, a network equipment, and a network interface card. The processing method for accelerating packet filtering includes the following steps.

A rule chain including a plurality of packet filtering policies is loaded (step S110). A plurality of packet data is received (step S120). A grouping procedure is performed on the packet filtering policies according to feature values of the packet filtering policies, so that the packet filtering policies meeting threshold values are set as a policy group (step S130). All of the packet filtering policies that match a policy group are added to this policy group. The packet data is filtered by using the policy group respectively (step S140).

It is determined whether the packet data matches the policy group or not (step S150). If the packet data matches the policy group, a packet filtering process is performed by using each packet filtering policy in the policy group (step S151). If the packet data does not match the policy group, a new policy group is added dynamically (step S152). The step of adding a new policy group is determined based on the protocol of the packet data. If the packet data does not match any packet filtering policy in the policy group, the packet data is processed according to a preset processing policy (step S153). The preset processing policy can be set as passing, discarding, or retaining the packet data, and the like.

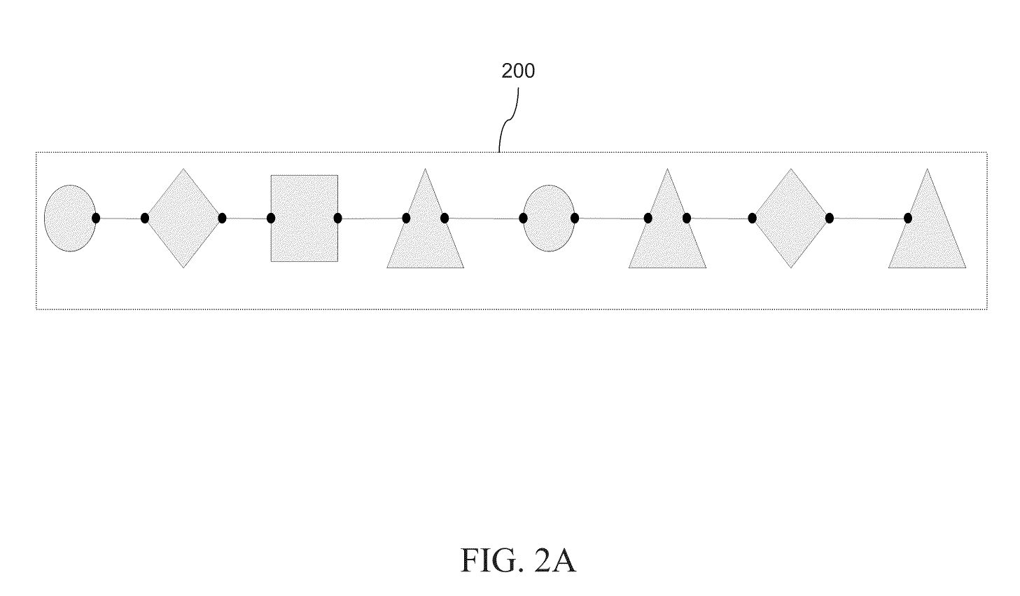

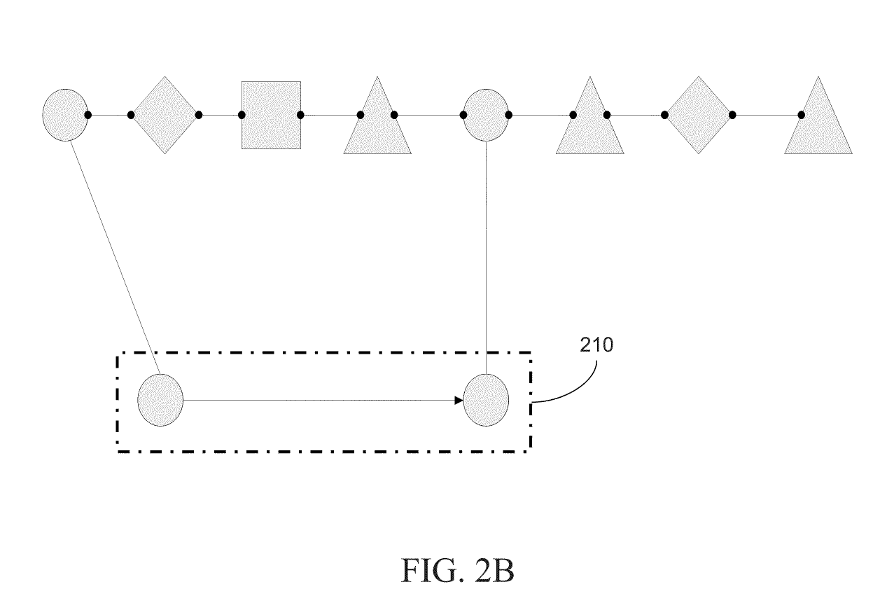

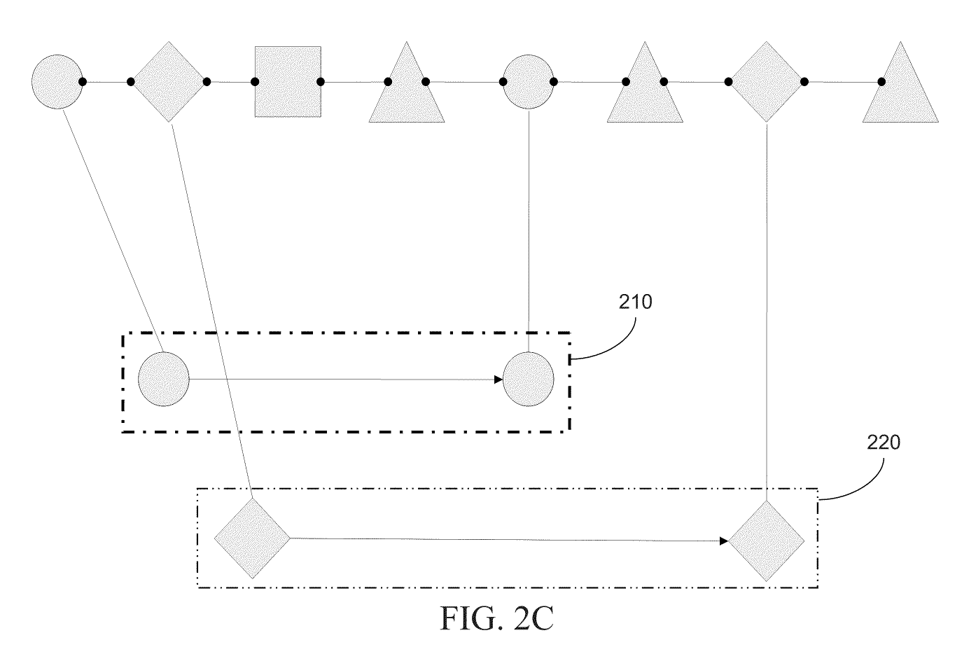

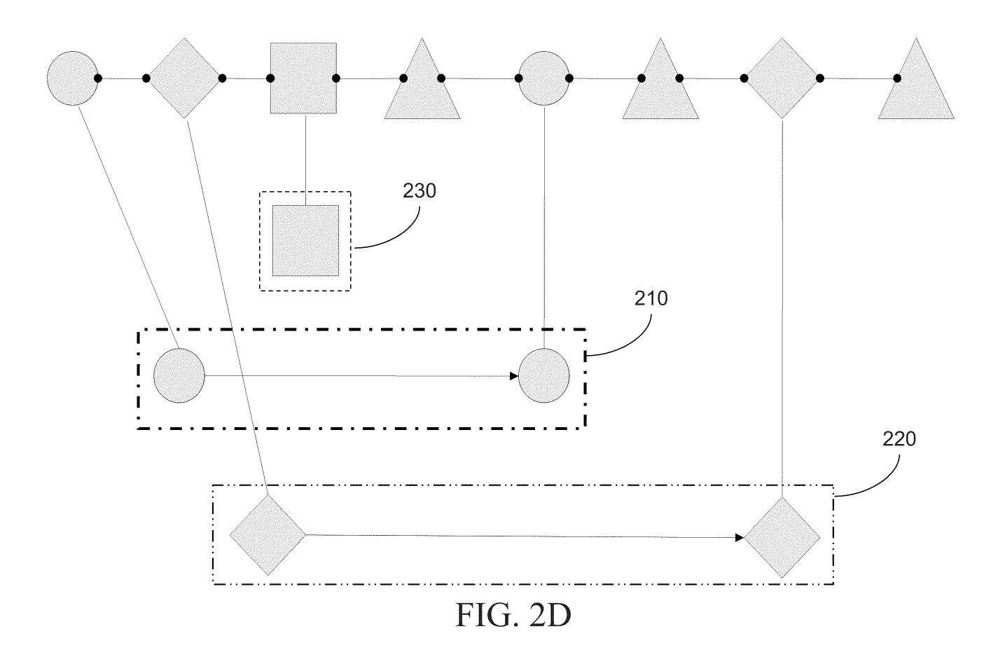

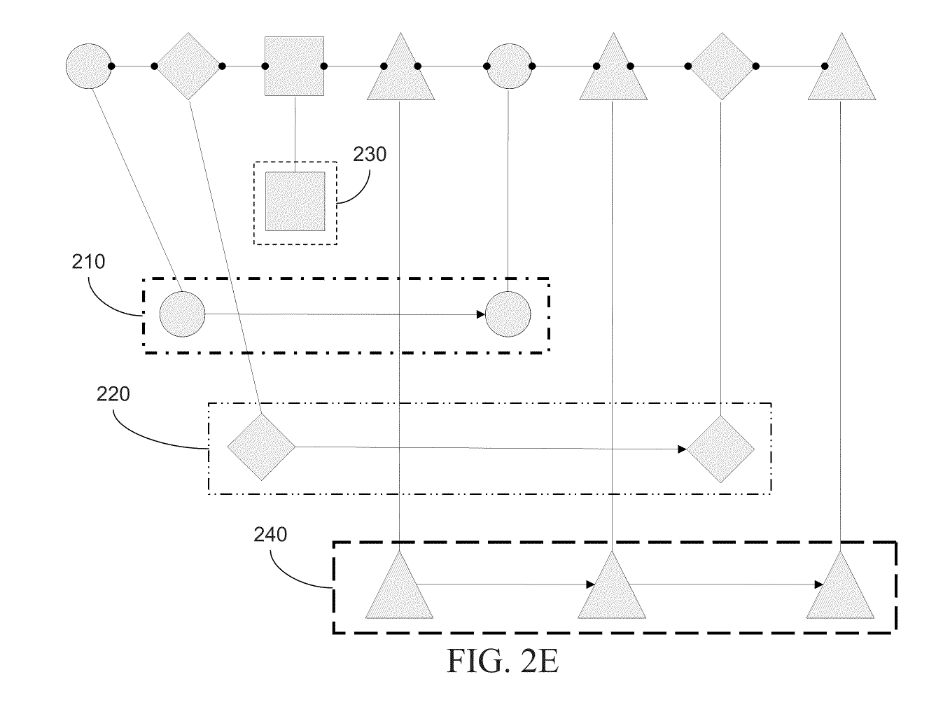

To facilitate illustrating the spirit of the present invention, nodes of different forms are taken as examples of different filtering policies and are not limited to the number as described. Referring to FIG. 2A, a schematic view of a filtering policy in a rule chain is shown. To facilitate illustrating, the different filtering policies with different feature values are shown in different shapes such as circle, diamond, square, and triangle in FIG. 2A, and the groups of filtering policies with the same feature values are referred to as a first policy group, a second policy group, a third policy group, and a fourth policy group. The feature values are resolved for the filtering policies here sequentially from left to right and according to the received packet data.

In the present invention, the feature values can take the network protocol or the type of network services in the received packet data as the condition of feature values. For example, in all the link layer packages, Ethernet, token ring and the like are in the first layer, ARP, RARP, IPV4, IPV6 are in the second layer, and TCP, UDP, ICMP, IGMP, SCTP are in the third layer. A corresponding set value is assigned to them, and then the feature values of the packet filtering are resolved according the set values for the above-mentioned packet filtering policies. Accordingly, the following set values can be assigned to the various protocols and services described above.

//layer 2 mask define

#define IPV4_MASK 1 //00000001

#define IPV6_MASK 2 //00000010

#define ARP_MASK 4 //00000100

#define RARP_MASK 8 //00001000

//layer3 mask define

#define TCP_MASK 1 //00000001

#define UDP_MASK 2 //00000010

#define ICMP_MASK 4 //00000100

#define SCTP_MASK 8 //00001000

Therefore, the system is adapted to resolve the feature values of each packet filtering policy, thereby producing corresponding policy groups. Referring to FIG. 2B, a schematic view of a first policy group of the present invention is shown. A grouping process is performed on neighboring filtering policies from the leftmost of FIG. 2B. In FIG. 2B, the “circular” filtering policies in FIG. 2A are grouped as a first policy group 210. Referring to FIG. 2C, a schematic view of a second policy group of the present invention is shown. After the step of grouping the first policy group 210, another grouping process is performed on a next filtering policy. The “diamond” filtering policies in the rule chain 200 are grouped in FIG. 2C. And the “diamond” filtering policies that are grouped as a second policy group 220. Likewise, the “square” filtering policies and the “triangular” filtering policies are grouped to produce a third policy group 230 and a fourth policy group 240. Referring to FIG. 2D and FIG. 2E, schematic views of a third and a fourth policy group of the present invention are shown respectively.

After the above policy groups have established, the performing sequence of the rule chain 200 in FIG. 2A is changed. Two rules for the sequence of the change are described as follows.

In Rule 1, the performing sequences of filtering policies in each policy group are connected in series. For example, the filtering policies in the policy group 210 are the first and the fifth filtering policy in the FIG. 2A. After grouping, the filtering policies included in a policy group are performed one by one.

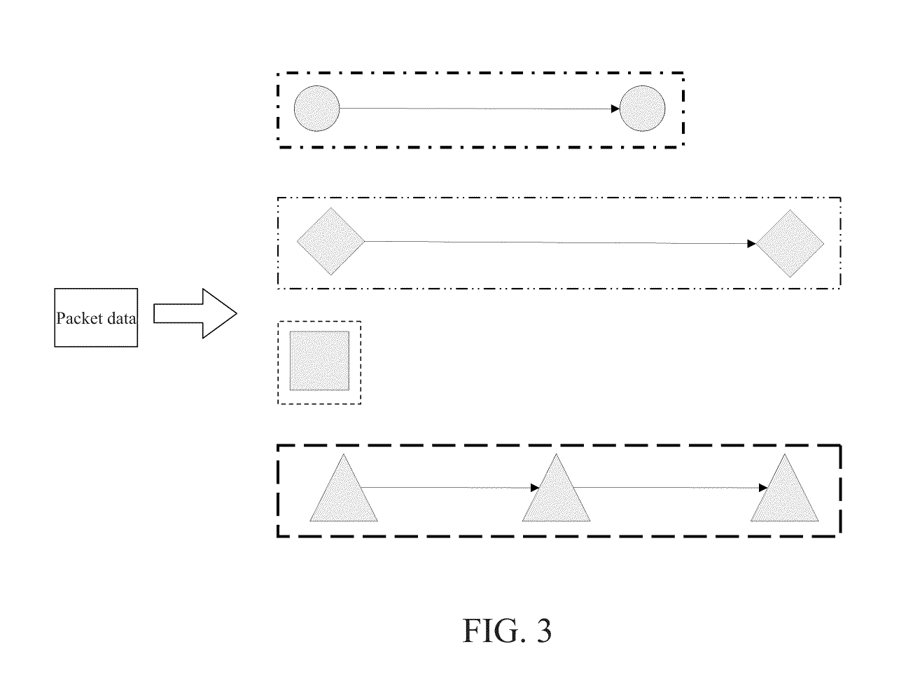

In Rule 2, the producing sequence of policy groups is taken as a new sequence of rule chain 200, as referred to FIG. 3, a schematic view of the performing sequence of the present invention is shown. In particular, in the present invention, similar filtering policies are first classified into the same policy group, and then one of the policy groups is selected to filter the packet data.

In addition, whenever a policy group processes a packet, as long as the packet does not match any filtering policies in the policy group, the system performs corresponding filtering process on the packet data according to a preset processing policy. The preset processing policy performs the following steps according to the protocol information of the packet: adding policy groups, passing the packet, or discarding the packet. This can not only guarantee the transparence of the dynamic generation of the policy groups to the administrator, but also guarantee that all necessary policy groups are always generated in particular application environment.

In the present invention, a regular grouping process is performed on a rule chain 200 performed sequentially, such that the filtering policies with the same feature values are integrated into one policy group, and then the filtering policies in the policy group are performed sequentially. In this manner, the complexities of the dispatch and comparison of resources is reduced, thereby accelerating the speed of filtering the packet data.

What is claimed is:

1. A processing method for accelerating packet filtering, applicable to a packet processing flow in a computer device, comprising:
loading a rule chain comprising a plurality of packet filtering policies;
receiving a plurality of packet data;
performing a grouping procedure on the packet filtering policies according to feature values of the packet filtering policies, wherein the packet filtering policies meeting a threshold value are set as at least one policy group;
filtering the packet data by using the policy groups respectively;
determining whether the packet data matches the policy groups or not;
performing a packet filtering process by using each of the packet filtering policies in the policy groups if the packet data matches the policy groups; and
processing the packet data according to a preset processing policy if the packet data does not match the packet filtering policies in the policy groups.

2. The processing method for accelerating packet filtering according to claim 1, wherein the grouping procedure further comprises:
determining a performing sequence of the packet filtering policies in the policy group according to a performing sequence of the packet filtering policies.

3. The processing method for accelerating packet filtering according to claim 1, wherein the grouping procedure further comprises:
determining a performing sequence of the policy groups according to a producing sequence of the policy groups.

4. The processing method for accelerating packet filtering according to claim 1, wherein the step of filtering the packet data by using the policy groups respectively further comprises:
adding a new policy group dynamically according to protocol information of the packets if the packets do not match any of the filtering policies.
